(19) United States
(12) Patent Application Publication
(10) Pub. No.: US 2014/0036682 A1
(43) Pub. Date: Feb. 6, 2014

(54) Load Balancing Based on TRILL

(71) Applicants: Xiaoqiang Tian, Haidian District (CN); Wenyu Zou, Haidian District (CN); Jun Zhao, Haidian District (CN)

(72) Inventors: Xiaoqiang Tian, Haidian District (CN); Wenyu Zou, Haidian District (CN); Jun Zhao, Haidian District (CN)

(73) Assignee: Hangzhou H3C Technologies Co., Ltd., Hangzhou, Zhejiang (CN)

(21) Appl. No.: 14/111,566

(22) PCT Filed: Jun. 14, 2012
(86) PCT No.: PCT/CN2012/076897

§ 371 Date: Oct. 14, 2013

(30) Foreign Application Priority Data
Jun. 14, 2011 (CN) 201110159582.4

(51) Int. Cl. H04L 12/803

(52) U.S. Cl. CPC H04L 47/125
USPC 370/235

(57) ABSTRACT

A method for load balancing based on Transparent Interconnection of Lots of Links (TRILL) is provided. Said method comprises: acquiring, by a routing bridge (RB), all current medium access control (MAC) addresses within each virtual local area network (VLAN) on a link where the RB is located. And if said RB is selected as a designated routing bridge (DRB), said RB distributes all the current MAC addresses acquired within each VLAN between said RB and other RBs on the same link according to a preset distribution rule, and notifies said other RBs to be responsible for forwarding of messages having a specified MAC address and VLAN, wherein said MAC addresses are the MAC addresses of the host devices on the link where said RB is located. If said RB is a common RB, said RB receives a notification sent by a DRB and learns that it is responsible for forwarding of messages having a MAC address and VLAN specified in said notification; and upon receiving a message sent by a host device, said RB determines whether said message is a message it is responsible for forwarding according to the VLAN and the MAC address of the host device carried by the message; if yes, said RB forwards said message; and if no, said RB discards said message.

### BACKGROUND

Transparent Interconnection of Lots of Links (TRILL) is the L2 network standard recommended by Internet Engineering Task Force (IETF). The TRILL uses a link state routing mirror network and discovers and calculates the shortest path between TRILL nodes which is referred to as a routing bridge. This achieves shortest path multi-hop routing, which enables a user to build a large scale Ethernet and Fibre Channel over Ethernet (FCoE) data center network. Because large data centers begin to use new technologies such as FCoE to converge storage transmission and IP transmission onto the Ethernet connections, so the standard spanning tree protocol (STP) is no longer so suitable in this context, especially in large converged networks. Thus, in a large data centre, TRILL may play an important role in making the data center more dynamic.

### BRIEF DESCRIPTION OF THE DRAWINGS

The accompanying drawings illustrate various examples of various aspects of the present disclosure. It will be appreciated that the illustrated element boundaries (e.g., boxes, groups of boxes, or other shapes) in the figures represent one example of the boundaries. It will be appreciated that in some examples one element may be designed as multiple elements or that multiple elements may be designed as one element. In some examples, an element shown as an internal component of another element may be implemented as an external component and vice versa.

FIG. 1 illustrates a structural diagram of TRILL networking according to an example of the present disclosure;

FIG. 2 illustrates a flow chart of a method for load balancing according to an example of the present disclosure;

FIG. 3 illustrates a flow chart of another method for load balancing according to another example of the present disclosure;

FIG. 4 illustrates a flow chart of yet another method for load balancing according to yet another example of the present disclosure;

FIG. 5 illustrates a structural diagram of a load balancing device according to an example of the present disclosure; and

FIG. 6 illustrates a structural diagram of a load balancing device according to another example of the present disclosure.

### DETAILED DESCRIPTION

In the following, certain examples are described in detail with reference to the drawings.

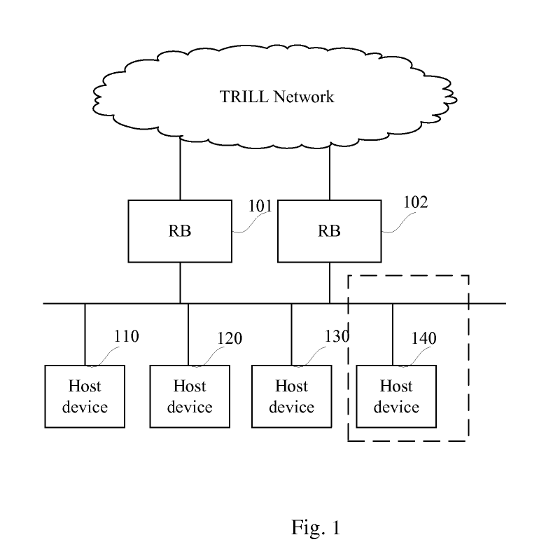

With reference to FIG. 1, FIG. 1 illustrates a structural diagram of TRILL networking according to an example of the present disclosure. In FIG. 1, two routing bridges RB 101 and RB 102 as well as four host devices (i.e. host device 110, host device 120, host device 130 and host device 140) exist on a link.

In this document, the term “Routing Bridge (RB)” refers to a network device that implements the TRILL protocol. The RBs in a RB campus, which consists of a network of RBs, bridges, hubs, repeaters, and the like, share connectivity information amongst themselves using a link state protocol. A link state protocol is one in which connectivity is broadcast to all the RBs, so that each RB knows about all the other RBs, and the connectivity between them. This gives RBs enough information to compute pair-wise optimal paths for unicast, and calculate distribution trees for delivery of frames either to destinations whose location is unknown or to multicast/broadcast groups. The term “link” means “bridged LAN”, that is to say, the combination of one or more network segments with zero or more bridges, hubs, repeaters, or the like. The term Designated Routing Bridge (DRB) refers to a RB that is elected from among all RBs on a link using a link state protocol. The DRB specifies the Appointed Forwarder (AF) for each VLAN and also specifies the Designated VLAN for inter-RB communication.

Although only one link is shown in FIG. 1, it will be appreciated that a TRILL network can include a plurality of links and each link may have one or more RBs and a number of host devices, wherein these host devices may belong to different VLANs. Because the way of appointing MAC addresses in each VLAN is the same, thus in FIG. 1, two VLANs (e.g. VLAN1 and VLAN2) are taken as examples, wherein it is assumed that a first VLAN (e.g. VLAN1) includes host devices 110, 120, 130 and 140, with their respective MAC addresses within VLAN1 being MAC10, MAC20, MAC30 and MAC40, and a second VLAN (e.g. VLAN2) includes host device 110 with its MAC address being MAC10.

Table 1 is a list of MAC addresses stored by an MAC address management module in RB101 and RB102. The MAC address management modules in RB101 and RB102 store the MAC addresses of VLAN1 and VLAN2, as shown in table 1.

TABLE 1

| VLAN | MAC Address |
|---|---|
| VLAN1 | MAC10 |
| | MAC20 |
| | MAC30 |
| | MAC40 |
| VLAN2 | MAC10 |

When the device is turned on, TRILL modules in RB101 and RB102 register with the MAC address management modules and the MAC address management modules send the MAC addresses in table 1 to the TRILL modules.

Assuming that RB101 is selected as the DRB. RB101 distributes the MAC addresses in VLAN1 evenly between RB101 and RB102, and an example of the distribution result is shown in table 2. Table 2 illustrates that RB101 distributes the MAC addresses between RB101 and RB102.

TABLE 2

| VLAN | MAC Address | RB Name |
|---|---|---|
| VLAN1 | MAC10 | RB101 |
| | MAC20 | RB102 |
| | MAC30 | RB101 |
| | MAC40 | RB102 |
| VLAN2 | MAC10 | RB101 |

After distributing each MAC address to a RB, RB101 sends a TRILL Hello message to RB102, to notify RB102 that it is responsible for forwarding messages with MAC20 and MAC40 in VLAN 1 and that RB101 is responsible for forwarding messages with MAC10 and MAC30 in VLAN1 and MAC10 in VLAN2. After receiving this TRILL Hello message, RB102 learns that it is responsible for forwarding messages with MAC20 and MAC40 in VLAN1 to the TRILL network. The specific content of the TRILL Hello message will be described below in detail.

When RB101 receives a message carrying VLAN1 and MAC10, it forwards the message to the TRILL network; and when RB102 receives a message carrying VLAN1 and MAC10, it will discard the message.

As shown in FIG. 1, when the host device 140 on the link is disconnected or turned off, and when an MAC address stored by the MAC address management module reaches an aging time, the lists storing MAC addresses in RB101 and RB102 will be updated, as shown in table 3. Table 3 is an updated list of MAC addresses stored by the MAC address management module. The MAC address management module sends the MAC address list shown in table 3 to the TRILL module. The RB that is selected as the DRB will redistribute the addresses and an example of the distribution result is shown in table 4. Table 4 illustrates that the DRB redistributes the MAC addresses between the RBs. Subsequently, a TRILL Hello message is sent to RB102, as described above, and the specific process will not be described in detail herein.

TABLE 3

| VLAN | MAC Address |
|---|---|
| VLAN1 | MAC10 |
| | MAC20 |
| | MAC30 |
| VLAN2 | MAC10 |

TABLE 4

| VLAN | MAC Address | RB |
|---|---|---|
| VLAN1 | MAC10 | RB101 |
| | MAC20 | RB102 |
| | MAC30 | RB101 |
| VLAN2 | MAC10 | RB101 |

In the above, sharing of traffic forwarding within a VLAN by multiple RB devices is described in detail by way of a specific example. Wherein, the even distribution principle is taken as an example of a preset distribution principle.

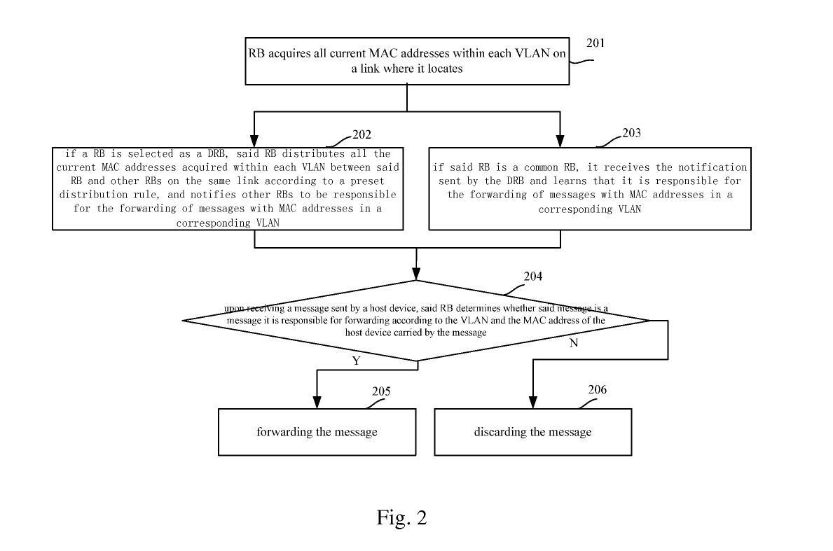

With reference to FIG. 2, FIG. 2 illustrates a flow chart of a method for load balancing according to an example of the present disclosure.

In 201, a RB acquires all current MAC addresses within each virtual local area network (VLAN) on a link where it locates. According to an example, after the system is turned on, each host device will send a message to RBs on the link and the MAC address of the host device carried by the message can be learned and stored by an MAC address management module of the RB. A TRILL module of each RB is registered with the MAC address management module, which will send the current MAC addresses within each VLAN to the TRILL module. The MAC address management module can send the MAC addresses to the TRILL module by storing two-dimensional information (VLAN, MAC address) in a list and upon receipt, the TRILL module will store the MAC addresses within each VLAN. In this way, a RB acquires all current MAC addresses within each VLAN on a link where it locates.

From block 201, the method shown in FIG. 2 branches to block 202 or block 203.

In 202, if the RB is selected as a designated routing bridge (DRB), said RB distributes all the current MAC addresses acquired within each VLAN between said RB and other RBs on the same link according to a preset distribution rule, and notifies other RBs to be responsible for forwarding of messages having a specified MAC address and VLAN.

In this example, the MAC addresses are the MAC addresses of the host devices on the link where the RB locates. Moreover, the preset distribution rule is a rule according to which all the MAC addresses acquired within each VLAN are distributed between the RBs. This distribution rule can be one that evenly distributes all the MAC addresses within each VLAN between all or several of the RBs on the link, or one that randomly distributes the addresses between the RBs on the link, or the rule can be set based on usage experience to distribute the MAC addresses between the RBs on the link.

Moreover, according to an example, the DRB notifies other RBs to be responsible for forwarding of messages having a specified MAC address and VLAN by sending a TRILL Hello message to other RBs.

In this example, the TRILL Hello message that is sent for notification will be extended from the original TRILL Hello message so that in terms of appointing a forwarder, the forwarder is identified by a VLAN, a RB Nickname and an MAC address instead of being identified by a VLAN and a RB Nickname. The following codes illustrates that the Appointed Forwarders sub-TLV of the TRILL Hello message is extended to add a field of an MAC address:

| | |
|---|---|
| Type=ApptFwrdrs | //(1 byte) |

| Length | //(1 byte) |
|---|---|
| Appointment Information (1) | //(6 bytes) |
| ................. | |
| Appointment Information (N) | //(6 bytes) |

The structure of each Appointment Information is as follows :

| | |
|---|---|
| Appointee Nickname | //(2 bytes) |
| MAC Address | //(6 bytes) |

| | |
|---|---|
| ................. | \| |

| MAC Address | | //(6 bytes) |
|---|---|---|
| RESV | Start.VLAN | //(1 bytes) |
| RESV | End.VLAN | //(1 bytes) |

Wherein, the MAC Address is a newly added field in the message and is used to indicate an MAC address specified for each Appointee Nickname.

In 203, if said RB is a common RB, it receives a notification sent by the DRB and learns that it is responsible for forwarding of messages having a MAC address and VLAN specified in the notification. In this example, a common RB indicates that this RB is not selected as the DRB.

From block 202 or block 203, the method shown in FIG. 2 proceeds to block 204, wherein upon receiving a message sent by a host device, a RB determines whether said message is a message it is responsible for forwarding according to a VLAN and an MAC address of the host device carried by the message. If yes, block 205 is performed, wherein the message is forwarded; otherwise, block 206 is performed, wherein the message is discarded.

Wherein, a common RB learns that it is responsible for forwarding messages with certain MAC addresses and corresponding VLAN specified in a TRILL Hello message sent by the DRB; and a RB that is designated as the DRB learns that it is responsible for forwarding messages with certain MAC addresses and VLAN when distributing MAC addresses according to the preset distribution principle. More specifically, the determining in block 204 and processing of a received message in block 205 and 206 are performed by each RB as follows.

Firstly, the RB determines according to a VLAN carried by the received message whether this message is a message it is responsible for forwarding or not. If no, the received message is discarded, as shown in block 206. If yes, then the RB further determines according to an MAC address of a host device carried by the received message whether this message is a message it is responsible for forwarding or not. If yes, then the received message is forwarded, as shown in block 205; otherwise the message is discarded, as shown in block 206.

It can be seen from the above that a RB only forwards a message if both the VLAN and MAC address of the message satisfy the requirement for the message it is responsible for forwarding. Otherwise the received message is discarded.

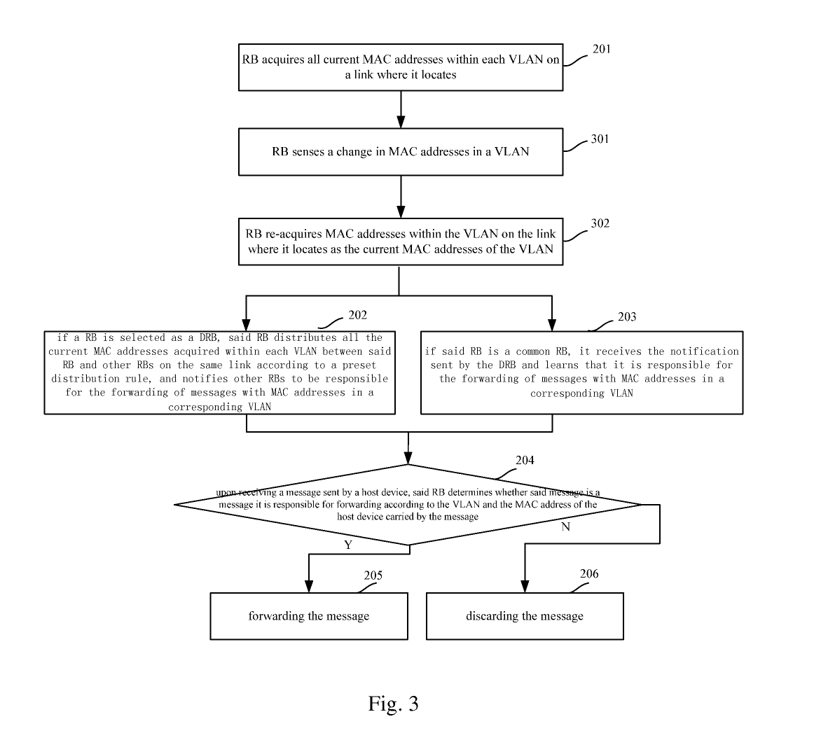

With reference to FIG. 3, FIG. 3 illustrates a flow chart of another method for load balancing according to another example. Here, except for block 301 and block 302, the method of FIG. 3 comprises the same blocks as the method of FIG. 2. Therefore, identical blocks having similar/same implementations and/or functions are denoted by the same numerals, and won't be described in detail herein for sake of simplicity. Referring to the example of FIG. 3, as shown in block 301, after the RB acquires all current MAC addresses within each VLAN on a link where said RB locates, the RB, more specifically the MAC address management module of the RB, senses a change in MAC addresses within a VLAN. Then, as shown in block 302, the RB reacquires all the MAC addresses within the VLAN on the link where said RB locates as the current MAC addresses of the VLAN. More specifically, because the TRILL module registers with the MAC address management module as described above, therefore when the MAC address management module senses a change in MAC addresses within a VLAN, the MAC addresses within this VLAN will be updated and stored and the updated MAC addresses within this VLAN will be sent to the TRILL module. Wherein, each MAC address within a VLAN corresponds to a host device on the link.

For example, when a host device on a link is turned off, or when a new host device joins the link, the MAC addresses of one or more VLANs on the link will change. In this case, the MAC address management modules of all RBs update their stored MAC addresses and send the updated MAC addresses to the TRILL module. After receiving the MAC addresses, the TRILL module updates the previously stored MAC addresses and at the same time, distributes them between the RB where the TRILL module is and other RBs on the same link according to a preset distribution principle.

Wherein, when a message sent by a host device on the link carries a new MAC address, that is to say, this MAC address of the host device cannot be matched in the MAC address management module, this new MAC address will be stored in the MAC address management module and the TRILL module will be informed of this.

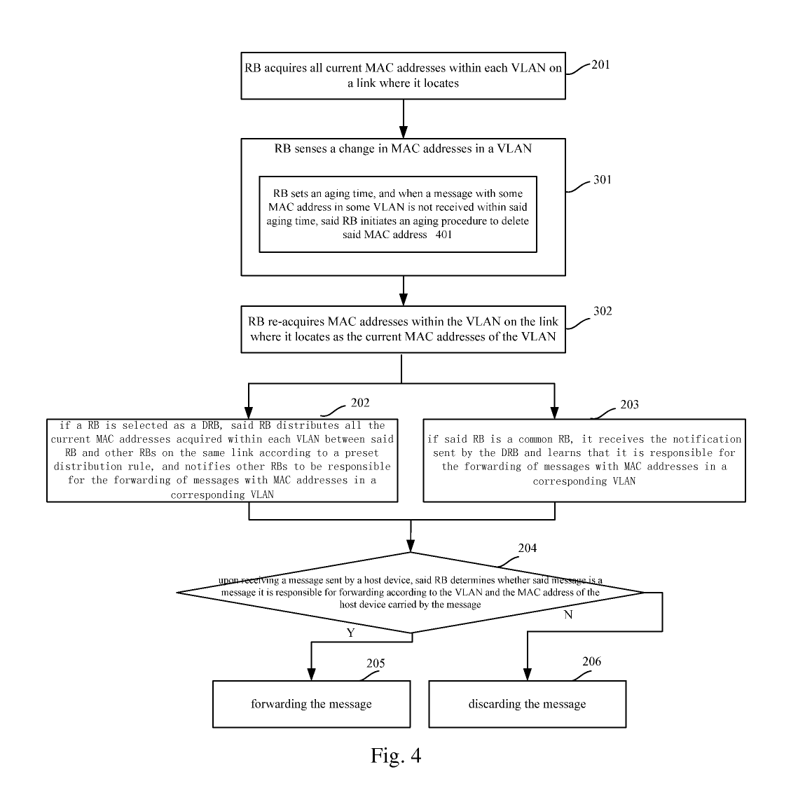

With reference to FIG. 4, FIG. 4 illustrates a flow chart of yet another method for load balancing according to yet another example. Here, except that block 301 in FIG. 3 further comprises a sub-block 401, FIG. 4 is almost identical to FIG. 3. Therefore, identical blocks having similar/same implementations and/or functions are denoted by the same numerals, and won't be described in detail herein for sake of simplicity. In this example, as shown in block 401, the RB sensing a change of MAC address within a VLAN comprises that: setting, by the RB, more specifically by the MAC address management module of the RB, an aging time. And when a message with an MAC address in a VLAN is not received within the aging time, an aging procedure is initiated to delete the MAC address and inform the TRILL module of the updated MAC addresses within the VLAN.

According to an example, when the DRB is reselected because of some situation in actual applications, the TRILL module of the new DRB will also redistribute the acquired MAC addresses between the RBs such that they will be responsible for forwarding messages having corresponding MAC addresses and VLAN. And the specific way of doing this is as described above.

In summary, according to an example, each of the RBs on the same link acquires all MAC addresses within each VLAN on the link where it locates. And a RB that is selected as the DRB is responsible for distribution of MAC addresses, wherein the DRB distributes the MAC addresses within the same VLAN between said DRB and other RBs on the same link according to a preset distribution principle (e.g. evenly), and notifies other RBs to be responsible for forwarding of messages with a specified MAC address and VLAN. Upon receiving a message sent by a host device, a RB determines whether to forward this message or not according to the VLAN and the MAC address of the host device carried by the message. In this way, the existing network resources can be fully used by multiple RBs sharing the forwarding of messages within the same VLAN. This can help prevent that one of the RBs on a link is overburdened while other RBs are idle, e.g. when this one of the RBs is selected as the forwarder of the VLAN and is responsible for forwarding messages from all the host devices within this VLAN into the TRILL network all by itself.

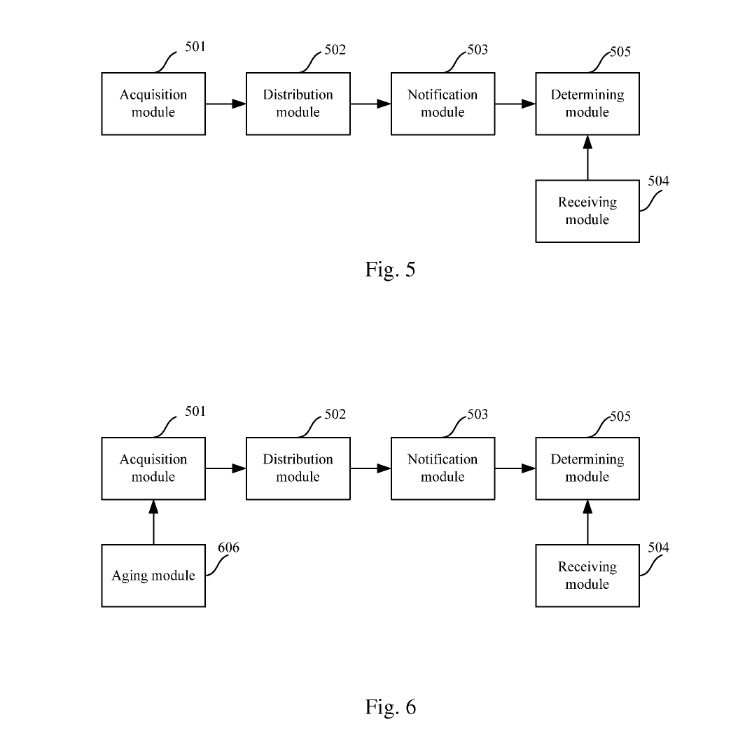

With reference to FIG. 5 now, FIG. 5 illustrates a structural diagram of a load balancing device based on TRILL according to an example of the present disclosure, wherein the load balancing device can be a RB. In this example, as shown in FIG. 5, the RB includes: an acquisition module 501, a distribution module 502, a notification module 503, a receiving module 504 and a determining module 505.

The acquisition module 501 in the RB is configured to acquire all current stored MAC addresses within each VLAN on a link where it locates, wherein the MAC addresses are the MAC addresses of the host devices on the link where the RB locates.

If the RB is selected as a DRB, the distribution module 502 distributes all the MAC addresses acquired within each VLAN by the acquisition module 501 between said RB and other RBs on the same link as said RB according to a preset distribution rule.

The notification module 503 is configured to notify other RBs to be responsible for forwarding of messages having a specified MAC address and VLAN, wherein said specified MAC address and VLAN for each RB is determined by the distribution of MAC addresses by said distribution module.

If the RB is a common RB, the receiving module 504 therein is configured to receive the notification sent by the DRB and learn that said RB is responsible for forwarding of messages having a MAC address and VLAN specified by said notification.

The determining module 505 is configured to, upon receiving a message sent by a host device, determine whether the message is a message said RB is responsible for forwarding according to the VLAN and the MAC address of the host device carried by the message; if yes, the message is forwarded; and if no, the message is discarded.

According to an example, the acquisition module 501 is further configured to re-acquire the MAC addresses within a VLAN on the link where it locates as the current MAC addresses of the VLAN when it senses a change of MAC address within the VLAN.

With reference to FIG. 6, FIG. 6 illustrates a structural diagram of a load balancing device according to another example of the present disclosure, wherein the load balancing device can be a load balancing RB. Here, except block 606, the device of FIG. 6 comprises the same blocks as the device in FIG. 5. Therefore, identical blocks having similar/same implementations and/or functions are denoted by the same numerals, and won't be described in detail herein for sake of simplicity. Referring to the example of FIG. 6, the RB further comprises an aging module 506.

The aging module 506 is configured to set an aging time for MAC addresses acquired in each VLAN by the acquisition module 501, and if a message with an MAC address in a VLAN is not received within the aging time by the acquisition module 501, the aging module 506 initiates an aging procedure to notify the acquisition module 501 to delete the MAC address. After receiving the notification sent by the aging module 506, the acquisition module 501 deletes the MAC address.

According to an example, the notification module 503 is configured to send a TRILL Hello message to notify other RBs to be responsible for forwarding of messages having a specified MAC address and VLAN; wherein the TRILL Hello message carries a VLAN, a RB Nickname and an MAC address.

As described above, an example of the present disclosure distributes MAC addresses of host devices in the same VLAN evenly between all RBs on the same link and informs other RBs to be responsible for forwarding of messages having a specified MAC address and VLAN by sending a TRILL Hello message. After the distribution is finished, multiple RBs share forwarding of messages within each VLAN, thus making full use of the existing network resources.

From the above depiction of the implementation mode, the above examples can be implemented by hardware, software or firmware or a combination thereof. For example the various methods, processes, modules and functional units described herein may be implemented by a processor (the term processor is to be interpreted broadly to include a CPU, processing unit, ASIC, logic unit, or programmable gate array etc.) The processes, methods and functional units may all be performed by a single processor or split between several processers. They may be implemented as machine readable instructions executable by one or more processors. Further the teachings herein may be implemented in the form of a software product. The computer software product is stored in a storage medium and comprises a plurality of instructions for making a computer device (which can be a personal computer, a server or a network device, etc.) implement the method recited in the examples of the present disclosure.

The figures are only illustrations of an example, wherein the modules or procedure shown in the figures are not necessarily essential for implementing the present disclosure. Moreover, the sequence numbers of the above examples are only for description, and do not indicate an example is more superior to another.

Those skilled in the art can understand that the modules in the device in the example can be arranged in the device in the example as described in the example, or can be alternatively located in one or more devices different from that in the example. The modules in the aforesaid example can be combined into one module or further divided into a plurality of sub-modules.

Although the flow diagrams described above show a specific order of execution, the order of execution may differ from that which is depicted. For example, the order of execution of two or more blocks may be scrambled relative to the order shown. Also, two or more blocks shown in succession may be executed concurrently or with partial concurrence. All such variations are within the scope of the present invention.

1. A method for load balancing based on Transparent Interconnection of Lots of Links (TRILL), wherein said method comprises:
acquiring, by a routing bridge (RB), all current medium access control (MAC) addresses within each virtual local area network (VLAN) on a link where the RB is located, and wherein:
if said RB is selected as a designated routing bridge (DRB), distributing by said RB all the current MAC addresses acquired within each VLAN between said RB and other RBs on the same link according to a preset distribution rule, and notifying said other RBs to be responsible for forwarding of messages having a specified MAC address and VLAN; wherein said MAC addresses are the MAC addresses of the host devices on the link where said RB is located;
if said RB is a common RB, said RB receiving a notification sent by a DRB and learning that it is responsible for forwarding of messages having a MAC address and VLAN specified in said notification; and
upon receiving a message sent by a host device, said RB determining whether said message is a message it is responsible for forwarding according to the VLAN and the MAC address of the host device carried by the message; if yes, said RB forwards said message; and if no, said RB discards said message.

2. The method of claim 1, wherein when said RB senses a change of MAC address within a VLAN, after said RB acquires all the current MAC addresses within each VLAN on a link where the RB locates, said method further comprises: re-acquiring by said RB the MAC addresses within said VLAN on the link where the RB locates, as the current MAC addresses of said VLAN.

3. The method of claim 2, wherein sensing by said RB a change of MAC address within a VLAN comprises:
setting by said RB an aging time, and when a message with a MAC address in a VLAN is not received within said aging time, initiating by said RB an aging procedure to delete said MAC address.

4. The method of claim 1, wherein said notifying other RBs to be responsible for forwarding of messages having a specified MAC address and VLAN is carried out by:
sending by the RB a TRILL Hello message to notify said other RBs to be responsible for forwarding of messages having a specified MAC address and VLAN; wherein said TRILL Hello message carries a VLAN, a routing bridge name (RB Nickname) and an MAC address.

5. A load balancing routing bridge (RB) based on Transparent Interconnection of Lots of Links (TRILL), wherein said RB comprises an acquisition module, a distribution module, a notification module, a receiving module and a determining module;
wherein said acquisition module is to acquire all current medium access control (MAC) addresses within each virtual local area network (VLAN) on a link where said RB is located, wherein said MAC addresses are the MAC addresses of the host devices on the link where said RB is located;
wherein if said RB is selected as a designated routing bridge (DRB), said distribution module is to distribute all the current MAC addresses acquired within each VLAN by said acquisition module between said RB and other RBs on the same link as said RB according to a preset distribution rule;
wherein said notification module is to notify other RBs to be responsible for forwarding of messages having a specified MAC address and VLAN; said specified MAC address and VLAN for each RB being determined by the distribution of MAC addresses by said distribution module;
and if said RB is a common RB, said receiving module is to receive a notification sent by a DRB and learn that it is responsible for forwarding of messages having a MAC address and VLAN specified by said notification; and
wherein said determining module is to, upon receiving a message sent by a host device, determine whether said message is a message which said RB is responsible for forwarding according to the VLAN and the MAC address of the host device carried by the message; if yes, then forward said message; and if no, then discard said message.

6. The RB of claim 5, wherein said acquisition module is further to re-acquire the MAC addresses within a VLAN on the link where it locates as the current MAC addresses of said VLAN when it senses a change of MAC address within said VLAN.

7. The RB of claim 6, wherein said RB further comprises an aging module; wherein said aging module is to set an aging time for an MAC address acquired in each VLAN by said acquisition module, and when a message with an MAC address in a VLAN is not received within said aging time by said acquisition module, said aging module initiates an aging procedure to notify said acquisition module to delete said MAC addresses; wherein after receiving the notification sent by said aging module, said acquisition module deletes said MAC addresses.

8. The RB of claim 5,wherein said notification module is to send a TRILL Hello message to notify other RBs to be responsible for forwarding of messages having a specified MAC address and VLAN; wherein said TRILL Hello message carries a VLAN, a routing bridge name (RB Nickname) and an MAC address.

9. A method for load balancing based on Transparent Interconnection of Lots of Links (TRILL), wherein said method comprises:
distributing all medium access control (MAC) addresses within each virtual local area network (VLAN) between a plurality of routing bridges (RBs) so that a message from said VLAN can be forwarded by a respective one of said plurality of RBs.

10. The method of claim 9, wherein said distributing is carried out by a RB that is selected as a designated routing bridge (DRB) from said plurality of RBs and wherein said plurality of RBs are located on a link where said VLAN is.
